(19) United States
(12) Patent Application Publication
(10) Pub. No.: US 2017/0036737 A1
(43) Pub. Date: Feb. 9, 2017

(54) VELOCIPEDE GEARBOX WITH TWO OR MORE TRANSMISSION RATIOS

(71) Applicant: Stefano MANGINI, Nole, TO (IT)

(72) Inventor: Stefano Mangini, Nole (IT)

(21) Appl. No.: 15/106,603

(22) PCT Filed: Dec. 18, 2014
(86) PCT No.: PCT/IB2014/002859

§ 371 Date: Sep. 21, 2016

(30) Foreign Application Priority Data
Dec. 20, 2013 (IT) MI2013A002176

(51) Int. Cl. B62M 11/16; F16H 3/66; F16H 3/091; B62M 1/36; B62M 11/06

(52) U.S. Cl. CPC B62M 11/16; B62M 1/36; B62M 11/06; F16H 3/091; F16H 3/66; F16H 2200/0039; F16H 2200/0043; F16H 2200/0052; F16H 2200/0078

(57) ABSTRACT

The present invention relates to a multiple ratio gearbox particularly suitable for velocipedes, foldable or not, which aims to be versatile for use, and that substantially improves the performance of the velocipedes, making them similar to those that are normally defined good performance of the best known “bicycles”.

The present invention relates to a multiple ratio gearbox particularly suitable for cycles, foldable or not, which aims to be versatile, and that substantially improves the performance of the velocipedes, bringing them to be similar to those that are normally defined good performance of the well known “bicycles”.

With reference to the patent application concerning a variable trim velocipede filed by the applicant on the same date, it is increasingly widespread the use of velocipedes realized to be suitable to certain needs of the users, which have to be versatile depending on the place wherein said velocipedes are used. It is also a forefront objective to conceive velocipedes suitable for both comfortable and agile movement of the user, which are used also as tools for physical activity, and that also have a structure which encourages the physical characteristics of each user, allowing to be “adapted” to the environment of use, and that is simple and handy to use and carry, and require minimal maintenance.

All these features are the focus of actual interest for velocipedes, which are regaining the visibility and importance in the life of every day that they had lost for a few years in favor of the enormous development of motor vehicles.

It is therefore essential to meet the expectations of increasingly demanding users, by proposing a velocipede with the features described above, that is also powerful in terms of performance, and that to get the benefits of versatility described should not renounce to other relevant factors, so on this aspect it is focuses the object of the present invention.

It appears evident that a common velocipede of the prior art, can in no way be compared from the point of view of performance to a regular bicycle. In the state of the art, there are vehicles which are able to satisfy some specific requirements of a user wishing to use a velocipede and not a bicycle, and to this end looking for a space-saving vehicle, which is easy to handle, and therefore also of low weight, has a limited need for maintenance and a low risk of getting dirty, as well as having aesthetic benefits obtained by simplifying the transmission, which then usually has a smaller dimension. As extensively discussed in the patent application concerning the variable trim velocipede, there are such velocipedes able to operate without the central movement on which usually pedals are operating, and which comprises frames of reduced size and reduced pitch, which necessitate a minimum of mechanical maintenance, and that are free of grease or other lubricant elements that could easily contaminate the user. These vehicles of the prior art, already discussed in the cited patent application concerning the structure of a velocipede with variable attitude, however, have performance problems due to the type of gear ratio, i.e. a direct gear ratio, that can be reduced or multiplied in a constant mode, but that is not modifiable. This gives rise to additional problems, such as lack of optimal gear ratios to allow to maintain certain distance on changing various inclinations of the ground. Still, unicycles are a further example of the optimization of certain handling characteristics, such as compactness and versatility, however they are characterized by great problems in terms of balance, security, stability, aerodynamics and comfort. There are also unicycles transmission equipped with only two ratios without a fixed element in the fork, which interacts in the creation of the gear ratios; this variation of the ratios is operated in this case, as logical, by the feet. It appears in any case evident that, only two gear ratios, do not provide the variety of range of motion or a type of performance that is remotely comparable to those of a normal bicycle. Still, there are also gearboxes that can be positioned in a fixed manner on the hub of a bicycle, receiving the transmission by means of a chain, such as a Sturmey Archer gearbox, which can be locked alternatively to the solar or to the planetary or to the satellites; these gearboxes, however, are incompatible with velocipedes in which the central movement is coincident with the hub of the drive wheel. These gearboxes multiply the numbers of possible exchange ratios. Still, there are mechanisms of change of ratio directly connected to the shaft of the pedals, but they are also incompatible with the positioning inside the hub of the drive wheel and need a chain or a transmission belt for transmitting the rotation to the wheel.

Some of these gearboxes can significantly reduce the need for oiling the components of the transmission and the need for periodic maintenance operations, but none of them can operate without the transmission, which until now has always been made by means of a chain, with obvious probability of soiling the user, the chain in any case complicates the maintenance of the vehicle, increases the friction, the whole weight of the vehicle, and complicates the operation or the folding possibility of the vehicle itself. Again, such a gearbox affects the stability of the vehicle, and therefore creates steering complications, since the distribution of the weights in the vehicle complicates the maintenance of the balance of the vehicle itself, this just by thinking to assume different settings, such as a vertical or reclined attitude.

Many of these limits have been overcome by the vehicle described in the patent application filed by the applicant in the same date. Some of these limits, however, particularly those relating to the performance of the vehicle, will be overcome thanks to the multiple ratio gearbox described in the present invention. The use of said gearbox, in particular on the variable trim velocipede here cited, therefore allows, in a particularly advantageous way, to overcome all the limitations described herein before.

In the state of the art there are systems for changing the transmission ratio, that are at least potentially adaptable to velocipedes with the axis of the pedals coincident with that of the drive wheel, which have more than two transmission ratios. Moreover none of them are without components that are external to the hub of the wheel, such as chain transmission system or the like, that allows to control the change between the ratio by the hands, sensitive and reactive, rather than by the lower limbs, that are less suitable and used to adjust precisely controls. Nor are there transmission change gears, with or without a chain, able to multiply the number of transmission ratios without increasing the amplitude of the distance between the pedals, this aspect has a name known to those skilled in the bicycle industry, that is Q-factor, which for various reasons is considered advantageous if limited.

In addition, there does not exist internal hub changing gear ratio systems using the fork as a component of the structure of the change mechanism, thus allowing the full implementation of a gearbox, either sequential or planetary, that is with a solar, a planetary and satellites and between which a component is integrally fixed to the fork of the vehicle. Similar limitations hinder the competition between vehicles of the velocipede type, despite their high potential foldability and modularity than the bike type, which comprise also different potential of changing the transmission ratios in a wide multiplications range also when equipped with small wheels, also in the sector of intermodal mobility, that is particularly relevant, and corresponds to the growing awareness and need for environmental sustainability. This lack also precludes enjoying the performance benefits that certain configurations of velocipedes may with respect to the bicycle industry.

Said velocipede with variable asset, together with the gearbox with multiple change ratio according to the present invention, has therefore the purpose of combining in a single vehicle the performance advantages of a velocipede with traction in a vertical position, with not particularly back settled center of gravity, with respect to the drive shaft and a good handling and visibility, with the benefits of a reclined velocipede with low center of gravity, ideal for guiding downhill and the speed, or ideal even in plain or moderate climb.

The purpose of the present invention therefore is to disclose a gearbox for velocipede that is particularly, but not only, suitable for a velocipede with variable asset, which confers to said velocipede, which itself already presents numerous advantages compared to the cycles of the prior art, also further advantageous characteristics in terms of performance optimization of these cycles.

In particular, an object of this invention is to propose a particularly light gearbox that is suitable to be integrated with the handling characteristics and reduced weight of the velocipede as a whole, to meet the purposes of the invention.

Another object of the present invention is to disclose a gearbox with a wide variety of possibilities of movement depending on the conditions of use of the vehicle.

A further object of the present invention is to disclose a gearbox that has good performances and that is economical to produce.

Still, an object of this invention is to disclose a gearbox that is simple to assemble and that can be disassembled, together with the wheel, for example in the case of puncture when used on said velocipede with wheels equipped with tires, and which requires little maintenance.

A further object of the present invention is to propose a gearbox that allows to have high performance both from the point of view of the absolute speed achieved compared to the energy used to obtain the said speed, both in case of punctual speed than total speed. (this therefore allows to maintain a good speed for prolonged period of time and with easiness, without giving up the additional benefits that entails the velocipede such as described) thus able to offer improved performance for velocipedes, such as the one described in the cited patent application filed by the applicant on the same date, compared to those obtainable with gearbox with multiple transmission ratios of prior art that are usually used on vehicles of prior art.

The multiple rates gearbox described in the present invention is able to confer to said human traction vehicle performances that are similar to those of normal bicycles, which are usually much higher than those of the velocipede of common type.

Furthermore, the multiple ratio gearbox disclosed by the present invention advantageously confers to said velocipede with variable asset all the advantages of a velocipede with high performances, with good control of acceleration and of the speed. The exchange ratios allow to adjust from time to time the best rolling distance of the wheel for each pedal stroke of said velocipede to optimize the energy expense/performance obtained.

Advantageously, the multiple rates gearbox according to the present invention being particularly light allows to preserve the particularly positive characteristics of maneuverability and lightness of the velocipede described here, but rather be an integral part of them.

In particular the gearbox described by the present invention is possibly a gearbox of the epicycloid type with two or more gear ratios, particularly suitable to be used with a velocipede with variable asset that is equipped with a fork for mounting said gearbox on the central axis of the hub said velocipede.

These and further advantages characterizing the multiple change gearbox according to the present invention, will be evident from the following detailed description of some preferred embodiments, made with reference to the annexed drawings in which:

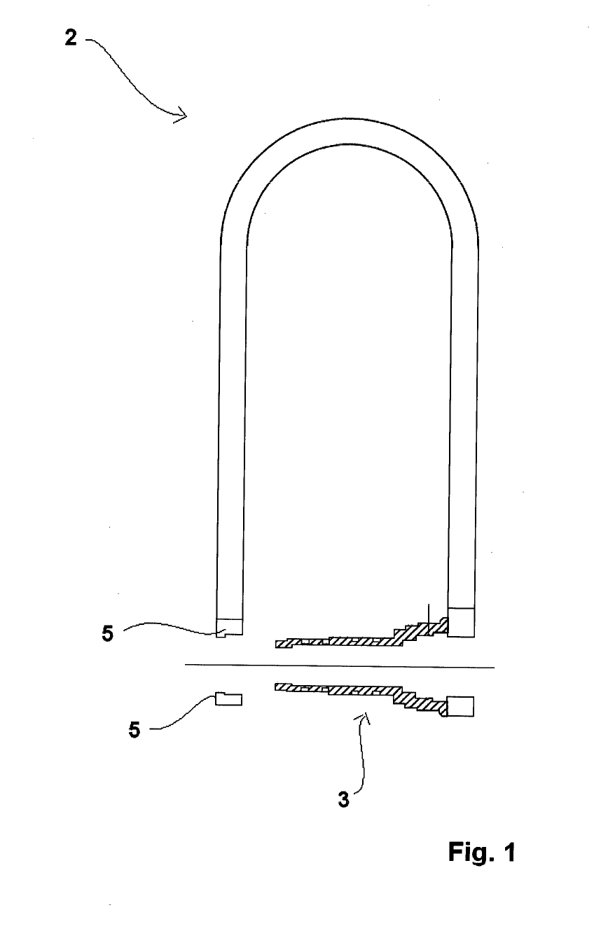

in FIG. 1 it is shown a detail of the velocipede on which the gearbox according to the present invention is mounted;

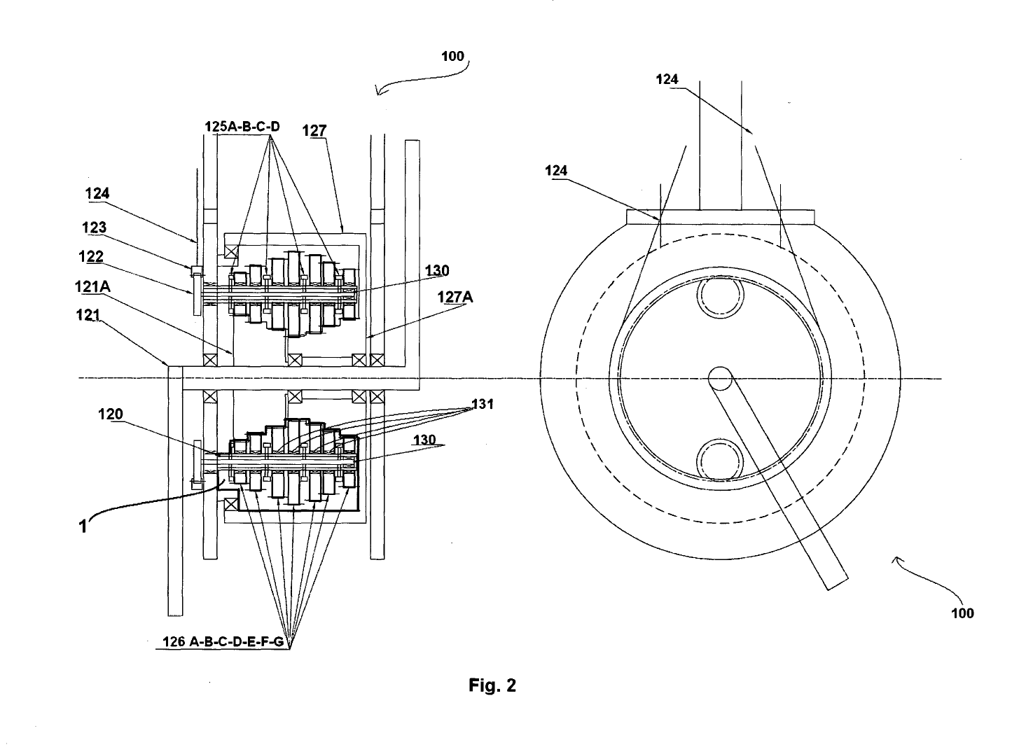

In FIG. 2 it is shown a detail of an embodiment of the gearbox according to the present invention, particularly suited to provide multiple gear ratios with reduced construction costs and limitation of the weights, in sectional and side view;

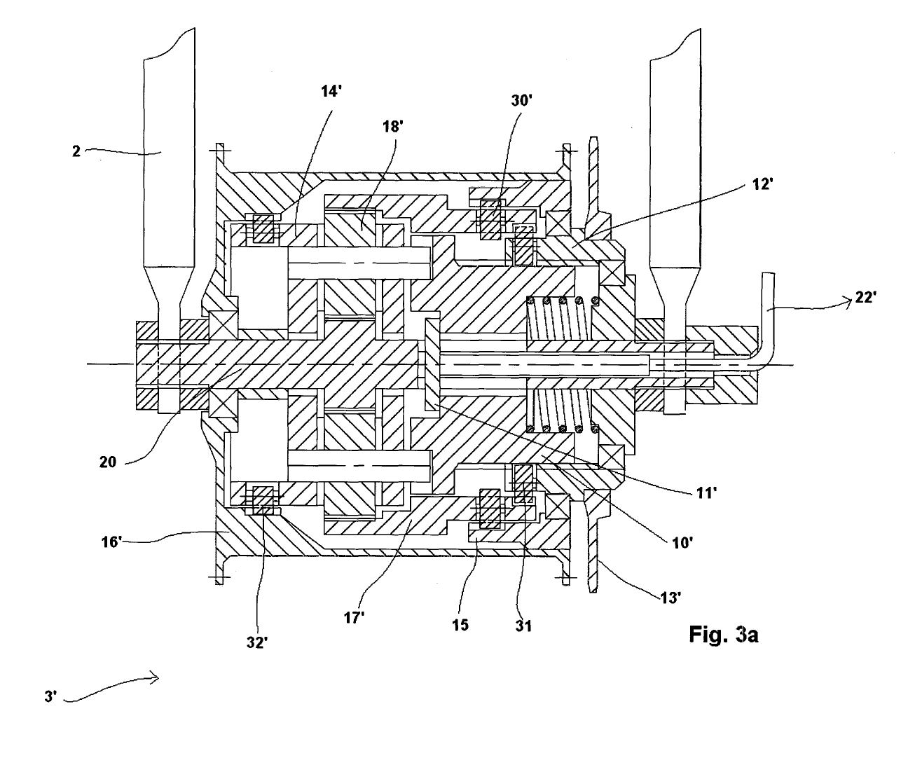

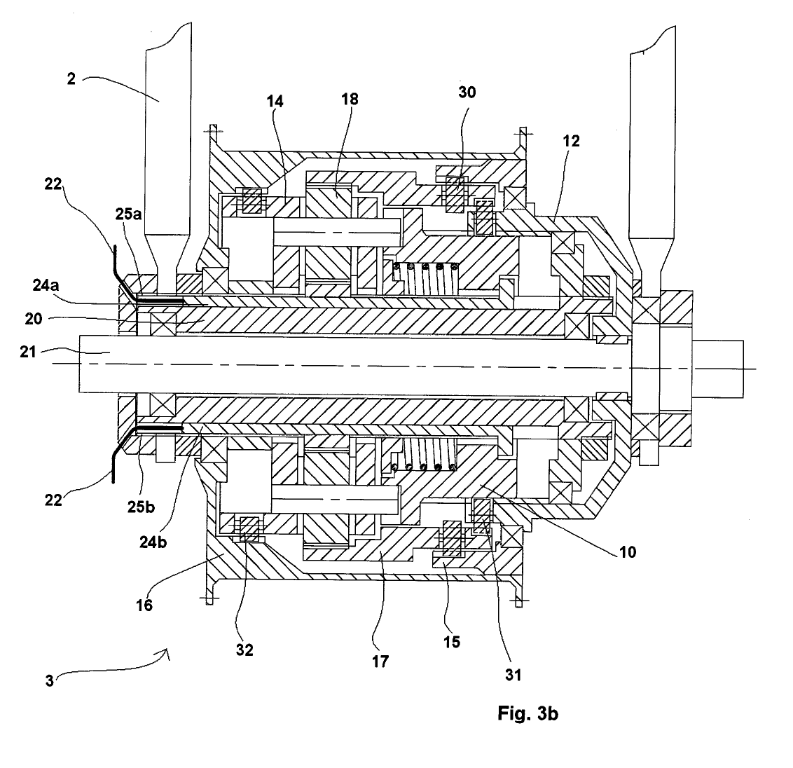

in FIG. 3a it is shown a section of an example of a planetary gearbox with three ratios of the prior art;

in FIG. 3b it is shown a section of an example of a planetary gearbox with three ratios according to the present invention;

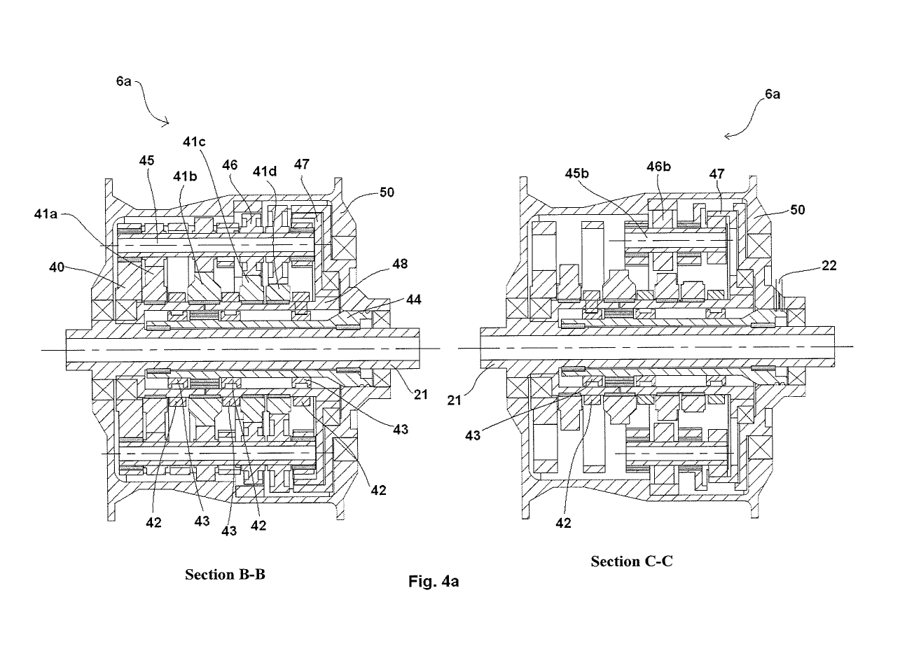

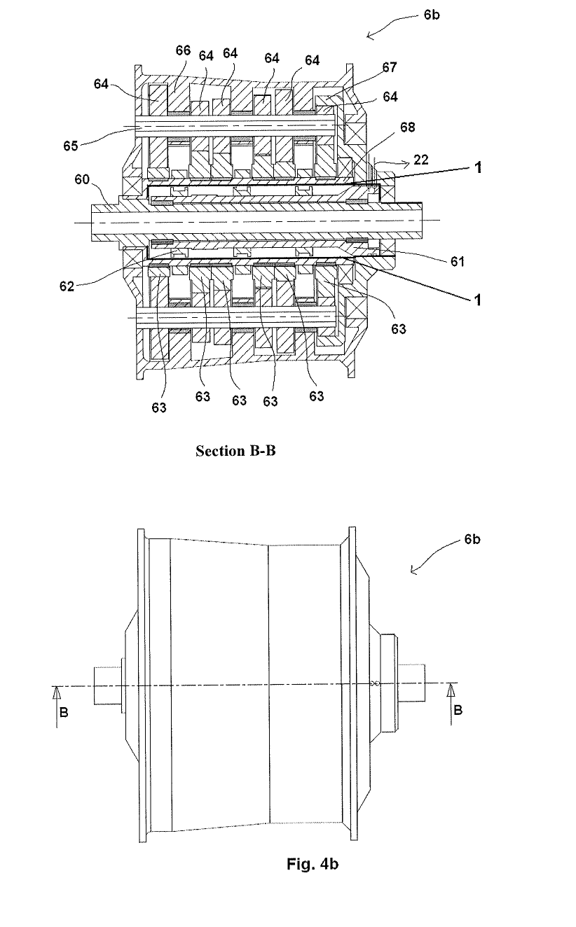

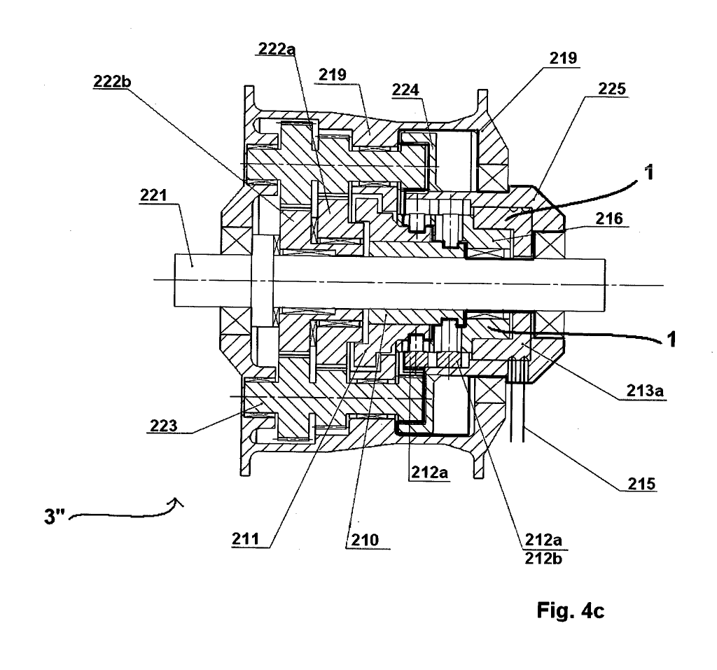

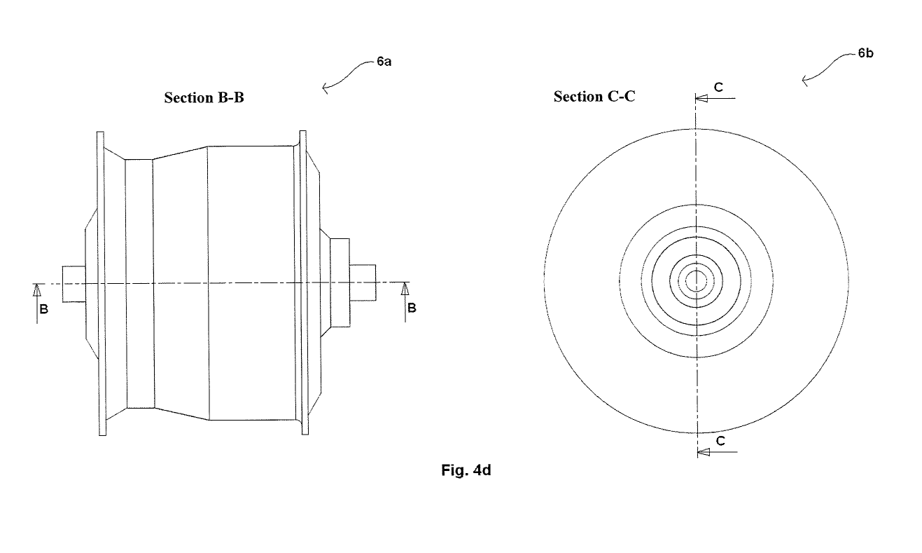

in FIG. 4d it is shown the external structure of the gearbox with reference to sections illustrated in FIG. 4a;

in FIGS. 4a, 4b and 4c are represented two sections of two embodiments of the gearbox according to the present invention of a six-speed gearbox with fixed satellite port, and respectively, at six and three relations with rotating planetary carrier, these last functioning as reducers;

in FIG. 4d it is shown an outer view of the sections analyzed in FIG. 4a;

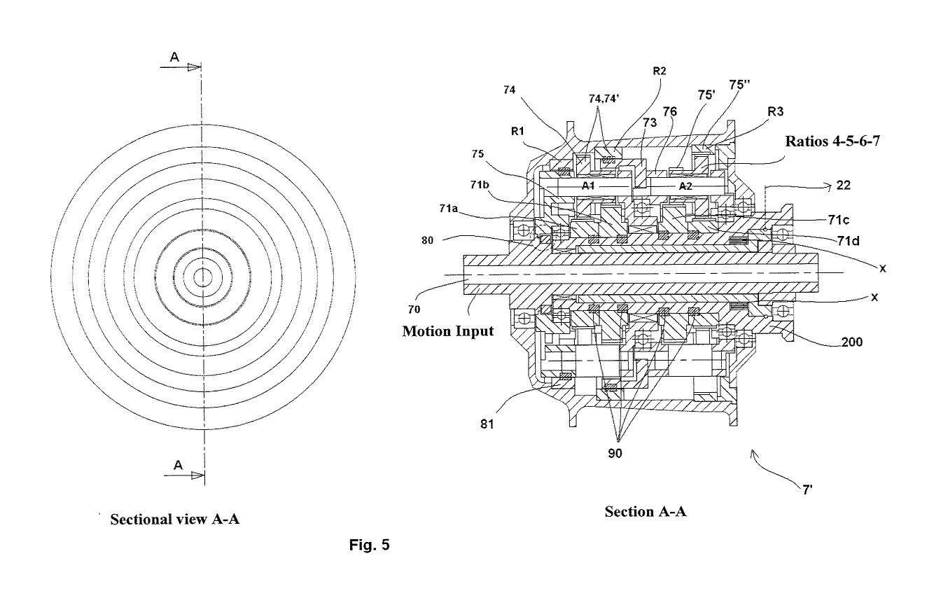

in FIG. 5 it is shown a section, with relative reference, of a further preferred embodiment of the gearbox according to the present invention that is a 7-speed epicycloid innovative gearbox;

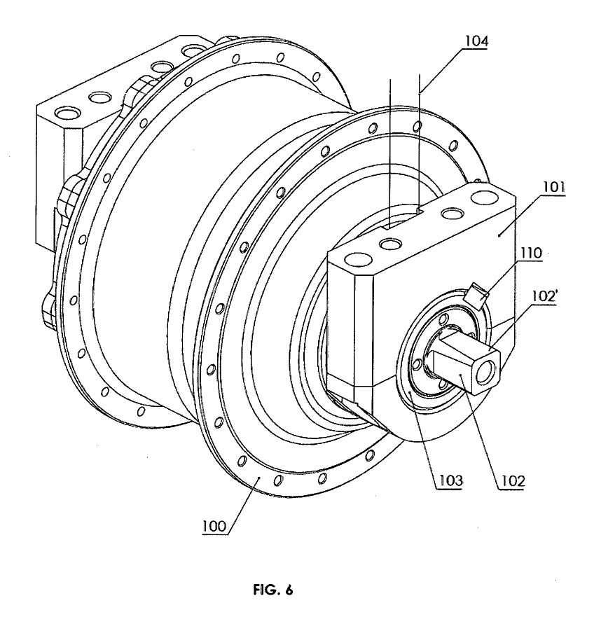

in FIGS. 6,7,8 there are visible realistic representations of prototypes of gearbox according to the present invention in perspective 3D, 2D lateral and frontal 2D view.

With reference now to FIG. 1, the gearbox according to the present invention is connected to the fork 2 by means of a fixed element 3, which fits into a specially designed cavity 1 of said gearbox; (said cavity, for uniformity of representation, will be defined always cavity 1, in all the embodiments of the present invention said cavity being very relevant to the invention). With the ability to block one or more elements of this element 3—which may possibly be rotating on itself and being corresponding to a satellites shaft, of a more or less sequential or epicycloid type (FIGS. 2 and 4a), or, only in the case transmission of the epicycloidal type, even to the shaft that carries the gears, that are commonly known as solar (FIGS. 5 and 3b), rather than to the outer ring known as the planetary gear (FIGS. 4b and 4c)—can be derive different gear exchange ratios that are determined directly by the sequential concatenation between toothed wheels or, in the case of epicycloidal, by the well-known formulas of Willis. Depending on the configuration of said fixed element 3, vary the possible configuration of that change, and with them the possible benefits. For example, said fixed element 3 may be coincident with the axis of the satellites, that is, with the shaft or through the planetary or with the axis known as solar, as presented in the figure. The fixed element 3 comprises, for each type of application, only on a portion of the space interval between the forks 2. There may be one or two forks 2, depending on the type of velocipede of interest. In correspondence of the support bearings 5 for connecting with the fork 2, it is possible to install multiplied transmission members that are eventually acting to change the gear ratio. In the present invention, therefore, advantageously, the multiple ratio gearbox is mounted on a central axis represented by said fixed element 3.

Substantially, said multiple ratio gearbox, mounted on said velocipede comprising the above described fork, comprising at least a fixed element engaged in the cavity 1, can be a gearbox with two or more ratios that, advantageously, compared to an epicycloidal gearbox, allows the multipliable or demultiplicabile action of the pedals on the same center of rotation of the drive wheel and therefore, can also be cheaper to produce compared to a conventional gearbox of similar conformation. Furthermore, by mounting such a gearbox on a velocipede comprising usually a normal gearbox, as mentioned, this would considerably lighten the overall weight of the vehicle, since it is no longer required the part of the transmission between different transmission centers, (this with reference to the wheel and driving axis of the pedals), which, as is known, overloads the vehicle. So now, in a particularly advantageous way, it is comprised in the center a hollow axle, within which is positioned the central movement, namely that of the pedals, and is placed inside the hub of the wheel, typically, but not necessarily, on the front wheel.

As described hereinbelow in detail of the figures, this innovative configuration is described by the preferred embodiment of the gearbox shown in FIGS. 2, 3b, 4a, 4b, 4c and 5.

Note that, in a particularly advantageous manner, in this way it is possible to make gearboxes with three transmission ratios, or even more advantageously six-speed transmissions, or even seven-speed and more, all of which maintain the advantageous characteristics described above, and thus enabling to reach the coveted goal of putting realistically in competition, from the point of view of performance, a velocipede and a traditional bicycle.

With reference to FIG. 2, there is shown a first variant of a preferred embodiment of the gearbox according to the present invention, which is particularly representative of the immediate advantages conferred by the use of this type of gearbox mounted on a velocipede as described above, this also without developing mechanisms typical of planetary change in the hub of the wheel (which will be described in subsequent embodiments, as a further advantageous alternative of said type of gearboxes). In fact, it is possible to develop a series of more or less efficient and simple solutions according to the scheme shown in the figure. A drive shaft 121 that connects two pedals, not shown here, rotates integrally with the motion of the legs of the driver/s, thereby actuating the rotation of the fixed element 120. The motion induces a rotation around the axis of the fixed element 120 for example by means of a screw 122. In this case said screw 122 is driven by a ring 123, carried by the cable 124, which is actuated by the driver himself. Such a screw 122, thanks to a riveting or any suitable coupling, which allows to move on an axis an element free to rotate on the perpendicular axis, sliding alternately left or right the rotary elements 125 A and 125 B, going to engage frontally and alternately the elements 126 A, 126 B and 126 C, otherwise free to rotate i.e. possibly on suitable bearings 131. These elements lead to the rotation of the fixed element 120. To transfer the movement from the wheel, the screw 122, rotating, causes one of the elements 125 C or 125 D to slidingly move to the right or left alternately, which allow to engage an integral rotation with the fixed element 120 special gears 126 D, 126 E, 126 F, 126 G. The last cited elements engage the gear wheels 129a, b, c of the elements 127 A, on which are connected the last four elements 126, (i.e. such as a series of rings, eventually separated between each other, acting jointly on the opposite side of the hub of the drive wheel 127), thus conferring to the outer casing of the hub of the drive wheel 127, a rotation in the same direction with respect to the pedals, but multiplied or geared down on the basis of the ratio between the motor shaft 121a, and alternatively 126 A, 126 B or 126 C and alternately between the elements 126 D, 126 E, 126 F or 126 G and the element 127 A. In this case, therefore, there are 12 different transmission ratios.

It is possible to support the fixed element 120, if necessary with suitable bearings, (here in this case not shown) inserted in a cavity, for example, in the wheel hub 127, both supported by elements connected to a possible extension of the fork 2 that depart on the same side on which the fixed element 120 is inserted, but going to support the other end, to support the fixed element 120 on the two sides.

Of course, it is possible to replace the front engagement 125 with radial or direct couplings, this avoiding to place the bearing between the drive shaft 121 which carries said bearings, and the gears 126 of said bearings; either by passing the graft 125 through one or more sections of bearings in which is formed an opening on the circumference of said bearings. Variations of this kind, although not shown here, are to be considered as an object of the present invention.

Furthermore, in this case it is realized a gearbox 100 with the fixed element that develops on two axes 13 located respectively at 180 degrees with respect to the center of the hub 127, but it is of course possible, by considering the construction needs, to realize a variable number of fixed elements 120, for example one or three or more, arranged in the second case at 120° to each other relative to the center of the hub 127.

Of course it is possible to increase or decrease the number and diameters of the gears connected, and increasing or not the number of gear ratios achievable and the variations of the gear ratios themselves. It is also possible to adopt and adapt, with variations in terms of weight and cost of construction, any system of sequential gearbox of prior art, whether or not comprising a direct clutch, gear ratios as well as multiplication ratios, an external control shaft 121 and whatever is obtainable through the attachment of further elements, possibly by using the formulas of Willis for the development gear ratios of epicycloidal type, with the possibility of being able to fix with appropriate commands, respectively, an element in the position of the solar or one that acts as a planetary. Moreover, as for example in FIG. 4a, it is possible to divide the fixed element in a fixed planet carrier component and a lead screw acting on the solar axis, keeping in this case the essence of a sequential gearbox, but making a reduction of the diameter of planet carrier shaft possible. Naturally in this case the screw for gear engagement may be placed on the opposite side to that of FIG. 2, as in FIG. 1 and in the following, and the components 121a and 127a must be replaced by half drive shafts on which the gears rotate alternately fixed by the coupling screw.

Therefore, it should be considered as an object of the present invention any form of sequential gearbox that can be applied to a human traction vehicle moved by pedals which act on the center of rotation of the drive wheel and, via a series of gears acting as a lever on a fixed element.

With reference now to FIG. 3a, there is shown a three ratios gearbox of epicycloidal type of the prior art 3′, which is here briefly described to better emphasize later the differences between a gearbox of the prior art of this kind and the gearbox with multiple ratios of epicycloidal type that is particularly innovative and realized according to the present invention; Usually, moving a generic gear lever, it is generating a displacement of the slider 10′ by means of a drive element 11 which is connected to the cable that goes to the handlebar. The slider 10′ has three positions, that as known correspond to three gears.

A gearbox, as for example a gearbox with three gear ratios 3′ comprises a slider 10′ which in the position shown here, has a slow ratio. The slider 10′ is driven from the grooved ring 12′ on which the carrying chain crown 13′ is fixed, and transmits the motion to the satellite carrier 14′ via a front coupling. In turn, the satellite carrier 14 transmits the motion to the outer gear ring 15′ via a pivoting coupling element 30′, pivoted to said outer gear ring 15′. Said outer gear ring 15′ is integral with the spokes carrying casing 16′, which brings the motion to the wheel.

Similarly, in the intermediate position of the slider 10′ there is a direct ratio, and in the position with the slider 10′ shifted to the right, there is fast motion. In the case of direct ratio, the slider 10′ actuates the tilting coupling element 31′, applied to the splined ring 12′, which engages the intermediated gear ring 17′, which in turn, similarly as described hear above engages with the outer gear ring 15′ thus bringing the motion out. The cursor 10′ does not transmits the motion, which is thus in this case passes directly from the grooved ring 12′ to the intermediate gear ring 17′.

Still, in the case of fast ratio, which coincides with the position of the slider 10′ to the right, the cursor 10′ actuates the coupling element 31′, disengaging the intermediate gear ring 17′ from the outer gear ring 15′. The coupling element 30′ remains engaged. The slider 10′ does not transmit the motion, which passes from the grooved ring 12′ directly to the intermediate gear ring 17′. The intermediate gear ring 17′ in turn transmits the motion to the satellites 18′, by rotating the satellite carrier 14′ that through the pivoting clutch element 32′, directly transmits the motion to the spokes carrying casing 16′. The central shaft 20′ of the gearbox is therefore in this case fixed, and is connected via a cable 22′ to the known gear commands.

It is to be noted in particular, that here and below the element 16′ is defined in many ways, as shown in various embodiments suitable to define the purpose of the invention, whereby in each case all the elements 127, 16′, 219, 81, although otherwise defined will clearly be for those skilled in the art, the same mechanical component, namely the hub of the drive wheel)

With reference now to FIG. 3b, is seems immediately clear to a person skilled in the art, that in the here described preferred embodiment of the three ratios gearbox 3 according to the present invention, said gearbox 3 comprises a fixed element 20 and a drive shaft 21, which is housed inside the fixed element 20. The motion is in this case transmitted from the slider of the gearbox 10, through the grooved ring 12 that is rigidly fixed with the motor shaft 21.

Note that, in a particularly advantageous manner, the internal drive mechanism remains unchanged. What has been inventively conceived is the system for changing the gear, which is located on the opposite side with respect to the same changing gear system 3′ known from the prior art, see the output of the cable exchange 22 in FIG. 2b. Furthermore, said system for changing gear has as drive element two opposing towed rods 24a, 24b, acting on the slider 10, determining the displacement of the slider. Said towed rods are housed in cavity 25a, 25b, formed in the fixed element 20. The three ratios gearbox 3 represented here, as is appears evident to a person skilled in the art, is ingeniously simple to construct, and is also economical. Obviously it is further advantageous to have an innovative gearbox, which allows to put the central movement, namely that of the pedals, internally to the hub of the wheel; having therefore a so-called donut gearbox, that is concentric, in the transmission of the hub the pedals in the center.

In FIGS. 4a, 4b and 4c are shown further epicycloidal embodiments of the present invention, where, advantageously, the change 6a is an example of embodiment of gearbox according to the present invention with a fixed planet carrier 40.

In this case, the motion enters from the drive shaft 21 of entrance of the motion and is transmitted to a set of four gears 41 (identified with 41a, b, c, d), coaxial to it, which alternate with the engagement rings 42 interposed between the gear 41. These engagement rings 42 are integral with the shaft and slide with respect to it thanks to the dedicated grooves. The engagement is in this case a clutch of front type. The engaging rings 42 are in turn driven by the desmo rings 43, which slide on a hollow shaft, defined clutch or desmo shaft 44, which is constituted by a thread or compatible element, with variable geometry, so that at each angular movement of the clutch shaft 44, corresponds the engagement of a particular gear of the four gears 41 above said. The desmo shaft 44 is operated by cable from the shift lever, not shown here. Said set of four gears is always and simultaneously in mesh with the planet gears 41 that rotate relative to an axis 45 that is integral with the planet carrier 40, where the planetary carrier 40 is, as mentioned, fixed. The motion that comes from one of the gears 41 of the four gears, passes from the satellite 46 and goes back to one of the gears of the quadruplet depending on the selected graft. Now the motion is transmitted to the satellite 46a of a second axis 45a, by means of an intermediate gear ring 47. These exchanges may occur when in particular the drive shaft 21 is coaxial with a second intermediate shaft 48, on which are keyed two of the four gears 41 of the quadruplet. The division between the drive shaft 21, and intermediate shaft 48, permits to obtain a 6-speed gearbox thanks to these couplings. Note that one of the six ratios is obtained without passing by the satellites 46, but engaging the drive shaft 21 with the intermediate shaft 48. The motion reaching the pair of satellites 46b of the second axis 45b is then transmitted to the outer ring 50. In FIG. 3c it is shown the gearbox of FIG. 3a as it appears externally in correspondence of the sections used for the description of FIG. 3a.

With reference now to FIG. 4b, it is shown an embodiment of the multiple ratios gearbox according to the present invention in which, in particular said change 6b in this case is six-speed with rotating planetary carrier. Correspondingly to FIG. 4c this gearbox only provides reduction ratios and, as such, is especially suitable to the most inaccessible climbs, or as an extra component to insert in gearboxes as the previous one (FIG. 4a) or the following (FIG. 5). In this case the motion entering from the motor shaft 60, is transmitted through the desmo exchange system, composed, as in the version of FIG. 4a, by desmo rings 62 and by a coupling shaft 61 for changing the rates, possibly of desmo type, to the sextuplet gear 63 coaxial to the motor shaft 60. Said sextuplet gear 63 is simultaneously coupled respectively with the sextuplet of satellites 64, which rotate relative to an axis 65 that is integral with the planet carrier 66. Said planet carrier 66 is rotating and also acts as a ring rays holder. The motion then passes directly from sextuplet of gears 63 to the outer ring 67 through a single motion shaft 66, which is in this case rotating. This occurs because one of the satellites 64 is in mesh with a fixed crown 67.

Please note that in this case, the outer ring 67 and the desmo shaft 61, are acting as fixed element 20, with reference to the other figures.

The rotating satellites carrier configuration allows to realize a gearbox that is particularly light and homogeneous, very economical to construct, with which it is particularly easy to develop low transmission ratios.

With reference now to FIG. 4c, there is represented a further example of the gearbox, in this case to reducer ratios, according to one particularly convenient embodiment in terms of weights, dimensions and friction with respect to a gearbox of the prior art.

A first embodiment with such characteristics, seems particularly suitable to realize a gearbox with few ratios such as the one represented in FIG. 4c, described here below.

The drive shaft 221 transmits the rotation in this case in a central way to the coupling ring of the third rates 210 and to that of the second and first 211, integral with the first.

These rings 210, 211 slide horizontally, actuated by desmo rings 212a and 212b, in turn activated by the desmo screw 216, which is moved from the gear ring for ratio changing 213a in turn moved by the gear shift cable 215. The engagement ring 211 can, scrolling to the right, trigger a direct transmission ratio that directly induces the rotation of the crown output motion 219. Alternatively, scrolling to the left, said engagement ring 211 activates the gear 222a. Said gear 222a, drives the satellite carrier shaft 223 that reacts on the planetary 224 connected to the fixed ring 225 and transmits the motion to the output motion crown 219. Similarly occurs when the desmo rings 212a, 212b are configured so as to leave in the middle and released position the engagement ring 211 and engaging the coupling ring of the third ratios 210, to the desmo ring 212b. Note that in this case, with reference to the other figures the planetary 224 and the desmo screw 216 are making the function of the fixed element 20. The particular configuration of this gearbox 3″ allows in a simple way to have reduction ratios that are very suitable to climb. Implementing said particular embodiment together with other embodiments of said gearbox, that instead multiply the rates, it is possible to offer the opportunity of providing gearboxes that reduce the rolling distance with respect to the diameter of the wheel.

It is to observe how, for the latter two gearboxes, by positioning the planetary 224 described in FIG. 4c and the planetarium 67 described in the previous FIG. 4b, below the satellite carrier shaft, the motion can be accelerated, but inverted with respect to the direction of travel. This can be used to realize a gearbox for velocipede which allows to go forward with a reverse rotation of the pedals, compared to the normal one, or to move forward vehicles that, instead of simple pedals, are actuated by extensions inverting the sense of rotation, such as levers in the form of an oscillating piston. Alternatively, by inserting an intermediate gear in this solution, it is possible to produce variations in the multiplicative ratio in the usual sense of rotation.

In a particularly advantageous way the gearbox according to the present invention, even if being of epicycloidal type, can be a seven or more multiplicative gears gearbox, and it is evident that this can bring relevant benefits and advantages from the point of view of the performance of a velocipede, that it is tilting or not. In FIG. 5 is represented an example of a preferred embodiment of said gearbox 7 provided with seven gear ratios, in this case, the ratio 1 is always engaged, except in a free-wheel mechanism 80 that allows the hub to rotate in the direction of gear even without that the shaft rotates in this direction. Such a connection is obtained (left side of FIG. 5), rigidly connecting the motor shaft 221, to the first satellites shaft 75 or A1, and outside the outer casing 81 through a second freewheel mechanism R1, which instead allows faster rotations compared to those which induces in the other direction of rotation with respect to the first free-wheel mechanism 80, ie in the direction of travel. This ratio is achieved without setting any solar or planetary or satellite. In the case in which, via the couplings 90a and 90b, actuated by the cable through the fixed element 200 thanks to the screw spiral X, the first sun gear 71a is fixed to the two satellites integral 74, the integral rotation of said two satellites 74 causes the planetarium 73 to develop an accelerated motion. In the case in which the second sun gear 71b it fixed at 74′, an even more accelerated motion is obtained. This coupling takes place through the third freewheel mechanism R2, with identical direction with respect to that of the motor shaft 221 and that induced by R1, free in the same direction of R1, between the planetary 73 and the outer casing, rotating in the same direction of rotation of the planetary 73, in these cases in an accelerated way with respect to the rotation of R1, which is allowed by the freewheel mechanism comprised. The clutches with the outer casing 81, either on the ratio 1-R1, then on the ratios 2-3, R2, are, in the case of a 1-R1, a direct clutch, and without satellites; and in the second case, i.e. on ratios 2-3-R2, a clutch connected to the planetary in turn connected to the second satellite, which is integral with the first, and said first and second satellite rotate together on the same bearing at the same speed, said speed determined by the rotation of the drive shaft 70 transmitted to the shaft 75 of the satellites 74 and 74′, and from the block of the gear 71a or 71b. These grafts R1 and R2 are always connected and active, but the free-wheel mechanism allows the outer casing 81 to rotate faster than what would be induced by the respective clutches R1 and also R2.

It seems clear, even only by limiting the functional assessment of these elements, how it is developable a three rates gearbox also without the need to enter a free-wheel mechanism corresponding graft R2, and how said gearbox is simple and functional, smooth in usage and lighter than adjustments of gearboxes know from the prior art like the one in FIG. 3b, which are used for similar purposes, when this is possible.

Thanks to said free wheel R2, and to the addition of a second planet carrier shaft A2 is possible to develop other even more accelerated exchange rates. These are possible through the transmission of motion of the planetary 73 to the second satellites carrier shaft A2 thanks to the junction 76. In the case of blocking of a solar 71a or 71b, such transmission is always active. When going to lock, always thanks to the exchange action on the fixed element 20, in addition to one of the two solar 71a or 71b alternately, or alternatively also one of the two solar 71 co 71d, which react on the pair of satellites 75, respectively 75i and 75″, thus producing a further accelerated motion. This allows the creation of four other transmission ratios via the output that acts as planetary R3, combined with the satellite 75″. If one of the two solar 71a and 71b corresponding to the pin, it is held fixed, and it is also fixed one of those corresponding to the second shaft 71c and 71d, there are achieved different gears: that is two other rates (if fixed at 71st 87) with (71a+71c) or (71a+71d) and the same with the second (71b to 88) (71b+71c) or (71b+71d).

So, with the rates produced by the first two solar (71a and 71b) alone and with the direct rates, seven gears are totally realized.

As it is usual in planetary gearboxes, for the purposes of a constructive balance, it is used to place multiple concentric and identical shafts, for example, three shafts, with an inclination angle of 120° between the respective centers.

For reasons of lightness, dimensions, cost and simplicity of construction it has been avoided here to insert a coupling, for example a frontal one, which could be attached or split into two parts the planetary 73. This can allow release. It is in any case possible to implement this solution for reducing friction.

It is to note further that in this case the ring 225 and the planetary 224 are acting as fixed element 20, described in the preceding figures.

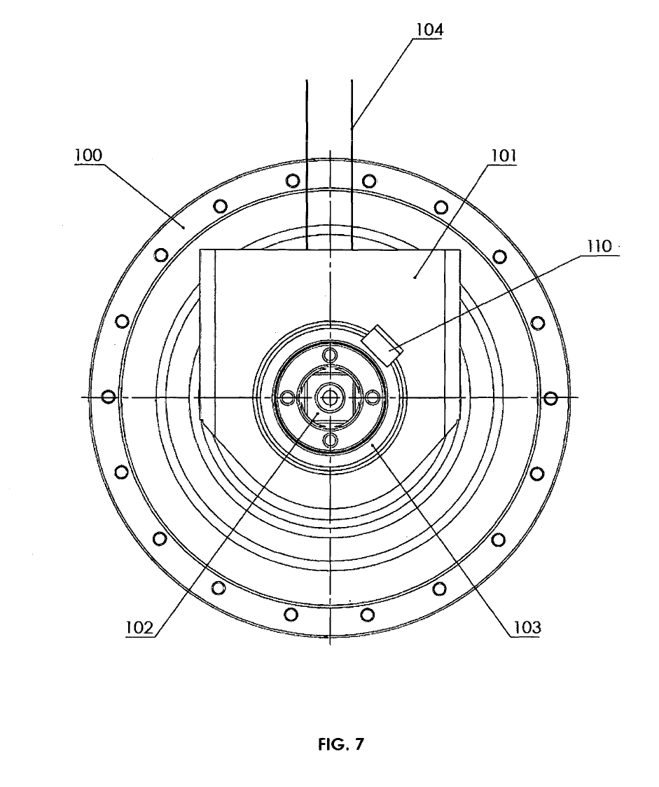

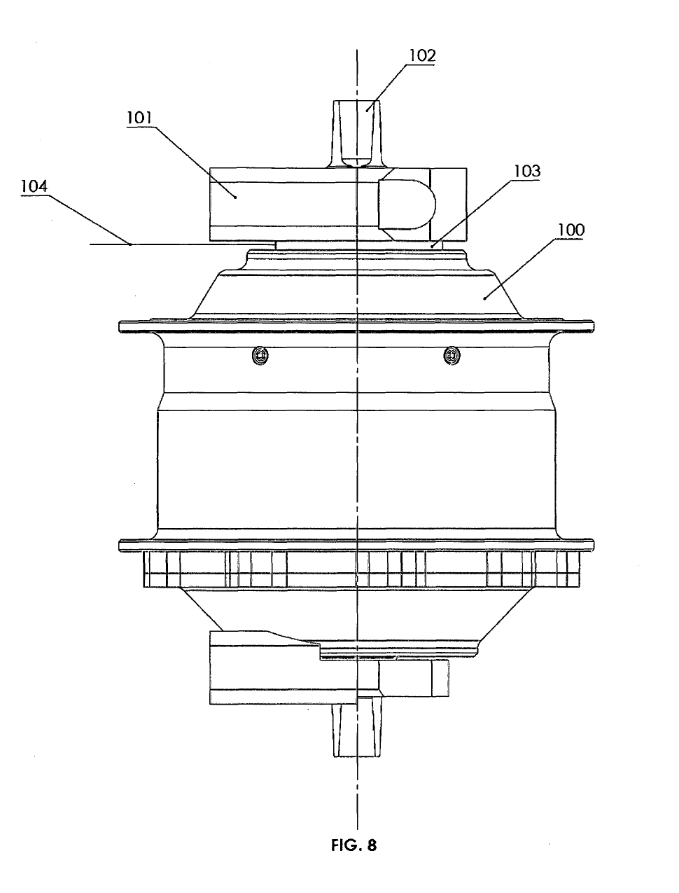

Finally, in a particularly realistic and advantageous way there are here attached in FIGS. 6,7 and 8, introduced for clarity of the inventive details already discussed, examples of a particularly preferred embodiment of the gearbox with the hub axle coinciding with the axis of the drive wheel that is in turn coincident with the axis of the pedals according to the present invention, advantageously able in an innovative way, as here said above, of realizing such a gearbox that is devoid of any chain transmission system or similar elements, as a multiple ratio gearbox. In said FIGS. 6, 7, 8 there are visible in different perspectives: the terminal part 101 of the fork 2, made integral to the fixed shaft or fixed element 3, 20, 103 via, for example in the present embodiment, a clamp closure and a dragging securing tab 110 which act to make the elements connected, (but this is just an example, said element and fork can also be realized in one piece, or connected through other means suitable for the purpose). Between the end portion 101 of the fork 2 and the outer case 81 or rail carrier 16, 16′ or the crown for motion output 219, defined in the present invention also as hub of the drive wheel 127 on which are applied the spokes 100, are housed means, such as for example, cables, made i.e. of steel 22, 104, whose movement allows the selection of the gear ratios. The propeller shaft 102 is housed coaxially to the fixed element 103,3,20,200 said propeller shaft 102, 21, 60, 70, 121, 221 comprises in the terminal part that juts out to the outside of the body of the gearbox a typical crank attack 102′.

In light of the embodiments described, it appears now evident, thanks to the present invention, how it is now possible without distorting the gearbox and without disproportionately increasing the overall dimensions, to deduce how it is possible with the insertion of some elements, such as solar or additional satellites, or even shafts, to develop exchange relationships with many more, for example ten or thirteen.

The opportunity of a simple development of additional solutions, besides a good constructive simplicity and a valid sequence of rates easily implementable and adaptable, make of this kind of gearbox the particularly preferred embodiment among those planetary here presented in order to illustrate some of the many variants of this system of gear transmission.

In view of the description of these figures it is therefore clear that the multiple ratio gearbox provided by the present invention is suitable to fill all earlier mentioned gaps that until now have characterized the velocipedes from the point of view of performance. Said gearbox with two or more gears acting as a lever on a fixed element that is rigidly connected to a portion of the fork, makes it possible to achieve a genuine sequential or epicycloidal gearbox, for transmission systems that are concentric and coaxial to the hub of the drive wheel. As has been described, being characterized by a direct drive from the shaft of the pedals to the transmission system coaxial to them on one side, while, on the same side in the case of sequential gearbox and on the other side in the case of epicycloidal, hosting on a fork a lift that allows remote control, through references made by means of cables or other, the arrangement of the gears, while providing a fixed support to allow the realization of a real system of epicyclical gearbox. The epicycloidal component can be, depending on the embodiments, the solar or the satellites or planetary being fixed, and respectively being the others mobile.

These then are just some preferred embodiments of the present invention, where the possible choice of the fixed component between the solar or planetary or satellites, offers advantages and disadvantages depending on specific configurations, of which have been given exemplifications rather binding, but valid as an example of the multiple potential embodiments arising from this kind of transmission, that is characterized by the factors described above, in particular: the transmission by the shaft of the pedals to the concentric hub on one side and a fixed element connected in a not modifiable way to the fork, through which also passes the transmission which allows the gears to settle in order to provide the multiple gear ratios. It should be noted, therefore, that any embodiments multiple rates gearboxes that include the elements here described, are to be considered subject of the present invention, and also said innovative gearbox, while being particularly suitable to be used with the variable asset velocipede described in the patent application filed on the same date by the applicant, is suitable to be used on any type of velocipede on which appropriate modifications are made, as described hereinbefore, and therefore, appropriate modifications may be made without departing from the scope of the present invention so as defined by the annexed claims.

1. A gearbox with two or more transmission ratios for velocipede, in case of epicycloidal type, comprising at least two shafts, a variable number of gears, an outer casing and at least a central cavity in which the shaft of the pedals of said velocipede is fixed, characterized in that it further comprises a second coupling cavity (1) for at least a fixed element (3,20,103,200,225) protruding from a fork (2) of said velocipede, said at least one fixed element comprising clutches (125, 10, 42, 62, 210, 211, 212, 90), and said gearbox comprising shafts, of which at least one drive shaft (21, 60, 70, 121, 221) and at least one planetary carrier (120, 45, A1, 65, 223) being positioned concentrically with respect to the central axis of the drive wheel and engaging said gears (18, 126, 121A, 127A, 41, 46, 63 , 64, 222, 223, 71, 74, 75) to one other, fixing some of them (18, 126, 41, 63, 222, 71) depending on the clutch (125, 10, 42, 62, 210, 211, 212, 90) selected from at least part of said at least one fixed element (3, 20), to obtain two or more transmission ratios on the hub of said driving wheel (127,16,219), said hub being coincident with the axis of the pedals of said velocipede and the axis of the drive shaft (21) of said gearbox being in turn coincident with the axis of the drive wheel of said velocipede, being in turn said axis of said motion wheel coincident with the axis of the pedal.

2. The gearbox with two or more transmission ratios for velocipede according to claim 1, wherein said drive wheel is the front wheel of said velocipede.

3. The gearbox with two or more transmission ratios for velocipede according to claim 1, wherein said gearbox has twelve transmission ratios and is of sequential type, and includes a drive shaft (121), rotating elements (125 A and 125B), engaging frontally and alternately the elements (126 A, 126 B and 126 C), said elements (126) supporting the rotation of the fixed element (120) and said fixed element (120) carrying the rotation, through the coupling of further elements (125 and 126, 127a) of the hub 127.

4. The gearbox with two or more transmission ratios for velocipede according to claim 1, wherein said gearbox (100) with twelve, four and six transmission ratios, comprises a drive shaft (121, 21) composed partially by the drive shaft (121A) and by an element (127A), or by said drive shaft (21) and an intermediate shaft (48).

5. The gearbox with two or more transmission ratios for velocipede according to claim 1, wherein said gearbox (6b) is a six-speed one, and of epicycloidal type, and the outer crown (67) and the coupling shaft (61) of said gearbox (6b) perform the function of the fixed element (20).

6. The gearbox with two or more transmission ratios for velocipede according to claim 1, wherein said six-speed gearbox is of epicycloidal type and said at least one fixed element (20) comprises at least one planet gear shaft (45) and a clutch shaft (44).

7. The gearbox with two or more transmission ratios for velocipede according to claim 1, wherein for the three-speed gearbox (3″) the planetary gear (224), the ring (225) and the desmo screw (216) perform the function of the fixed element (20).

8. A system for assembling a gearbox with two more gears according to claim 1, comprising at least one or more forks (2), characterized in that said at least one fork comprises at least one fixed element (3) for mounting said gearbox on said fork (2), in correspondence of the central axis of the hub of said driving wheel, coincident with the axis of the pedals of said velocipede.
